(19) United States
(12) Patent Application Publication
(10) Pub. No.: US 2003/0144441 A1
(43) Pub. Date: Jul. 31, 2003

(54) Controlled copolymerization of methyl acrylate with olefins under mild conditions

(76) Inventors: Ayusman Sen, State College, PA (US); Sharon Elyashiv-Barad, Rockville, MD (US); Shengsheng Liu, State College, PA (US)

Correspondence Address: Anthony J. DeLaurentis, Suite 311, 2001 Jefferson Davis Hwy, Arlington, VA, 22202, US

(21) Appl. No.: 10/291,506

(22) Filed: Nov. 12, 2002

Related U.S. Application Data
(60) Provisional application No. 60/337,698, filed on Nov. 13, 2001.

(51) Int. Cl. C08F 10/00

(52) U.S. Cl. 526/282; 526/319; 526/348.5; 526/348.6

(57) ABSTRACT

A copper-mediated process for the synthesis of random copolymers of methyl acrylate with non-polarolefins, ranging from ethene to 1-octene, norbornene and norbornene derivatives, and capable of synthesizing copolymers having greater than 5% incorporation of the olefin, as well as copolymers synthesized using the process are described. The process displays many of the characteristics of a living polymerization process: the polydispersities of the copolymers obtained are less than about 1.7, preferably from about 1.1 to about 1.4, and it is possible to synthesize novel block terpolymers of methyl acrylate with olefins by the sequential addition of the latter monomers.

### CROSS-REFERENCE TO RELATED APPLICATIONS

This application is based on to U.S. Provisional Application Serial No. 60/337,698, filed Nov. 13, 2001, and entitled “Controlled Polymerization of Methyl Acrylate With 1-Alkenes Under Mild Conditions.”

### BACKGROUND OF THE INVENTION

The copolymerization of polar vinyl monomers with nonpolar alkenes remains an area of great interest because the combination of the two can greatly enhance the range of currently attainable polymer properties. This interest can be seen throughout the current literature, for example, in Britovsek et al, Chem. Int. Ed. Engl. 1999, 38, 429; Ittel et al, Chem. Rev. 2000, 100, 1169; and Boffa et al, Chem. Rev. 2000, 100, 1479.

It is known that the polymerization of polar vinyl monomers, such as acrylates, occurs readily and under mild conditions by free-radical polymerization to yield high molecular-weight homopolymers. See, e.g., Odian, Principles of Polymerization; John Wiley: New York, 1991, 630, or Handbook of Polymer Synthesis, H. R. Kricheldorf, Ed.; Marcel Decker: New York, 1994, Ch.4. On the other hand, it is also known, that simple linear olefins, such as ethene and propene, undergo radical-initiated homo and copolymerization only under harsh conditions to yield branched materials. See, e.g., Handbook of Polymer Synthesis, H. R. Kricheldorf, Ed.; Marcel Decker: New York, 1992, Ch. 1. To date, the only successful radical-initiated copolymerization of acrylates with olefins under mild conditions (reported in Logothetis et al, J. Polym. Sci.: Poly. Chem. Ed., 1978, 16, 2797; Logothetis et al, J. Polym. Sci.: Poly. Chem. Ed., 1977, 15, 1431; and Logothetis et al, J. Polym. Sci.: Poly. Chem. Ed., 197, 15, 1441) involves the use of strong Lewis acids that complex to the ester functionality of the acrylate. The resultant highly electron-deficient monomer forms a 1:1 alternating copolymer with olefins in the presence of radical initiators.

In the area of metal-catalyzed insertion polymerizations, the copolymerization of ethene and acrylates with cationic palladium diimine compounds has been reported. See, e.g., Meking et al, J. Am. Chem. Soc. 1998, 120, 888, and Johnson et al, J. Am. Chem. Soc. 1996, 118, 267. However, a maximum incorporation of only about 12% methyl acrylate in the copolymer was achieved. A somewhat related system based on neutral nickel compounds that is able to polymerize functionalized alkenes was reported in Younkin et al. Science 2000, 287, 460. However, metal-catalyzed insertion polymerization using cationic neutral nickel compounds is generally ineffective for acrylates.

It is also known to copolymerize acrylates using metal-based catalysts that are traditionally used for atom transfer copolymerization. See, e.g., Matyjaszewski, Chem. Rev. 2001, 101, 2921; Kamigaito et al, Chem. Rev. 2001, 101, 3689; and Matyjaszewski, Controlled Radical Polymerization, Matyjaszewski, K., Ed.; ACS Symp. Ser. 1998, 685.

Accordingly, there exists a need for new polymerization processes and catalytic syntheses that will enable the copolymerization of acrylates with olefins under mild conditions. There is a further need for processes and catalyst systems that will enable the synthesis of copolymers of acrylates with olefins, wherein the resulting copolymers comprise from about 5 to about 50 mol % olefin moiety and are characterized by a low polydispersity. Still further, there is a need for processes and catalyst systems that will enable the synthesis of novel block copolymers including copolymers, terpolymers, etc., of acrylates and olefins by the sequential addition of the olefin monomer(s).

### SUMMARY OF THE INVENTION

It is an object of the present invention to provide polymerization process and catalyst system that is capable of copolymerizing acrylates with olefins under mild conditions to synthesize copolymers comprising from about 5 to about 50 mol % of olefin moiety.

It is another object of the invention to provide a polymerization process and catalyst system which is capable of copolymerizing acrylates with olefins under mild conditions and which displays many of the characteristics of a living polymerization system, thus allowing synthesis of unique block copolymers.

It is yet another object of the invention to provide a polymerization process and catalyst system for the synthesis of random copolymers of acrylates with olefins under mild conditions such that the resulting copolymers have a polydispersity of less than about 1.7.

These and other objects and advantages of the present invention are achieved by the copper-mediated synthesis of random copolymers of acrylates, such as methyl acrylate (MA), with olefins, such as ethene, propene and norbornene, at a temperature on the order of from about 20 to about 150° C., and typically at about 90° C., resulting in copolymers containing from about 5 to about 50 mol % of olefin derived units in the copolymer. The system displays many of the characteristics of a living polymerization system, allowing the synthesis of unique block copolymers.

### BRIEF DESCRIPTION OF THE DRAWINGS

The invention will be more fully understood when viewed in conjunction with the drawings, wherein:

FIG. 1 illustrates the acrylate-ethene-acrylate triad sequence in a methyl acrylate-ethene random copolymer;

FIG. 2 illustrates the APA, AAP, AAA, APP, PAP and PPP triad sequences for a methyl acrylate-propene copolymer, wherein A=methyl acrylate and P=propene;

FIG. 3 is a graphical representation illustrating the dependence of molecular weight, Mₙ, and molecular weight distribution, M_{w}/Mₙ, on total monomer conversion for the copper-mediated copolymerization of methyl acrylate with 1-octene, wherein the polymerization was performed at 90° C. in anisole, using 0.04 M CuBr, 0.04 M PMDETA, 0.04 M EBP, 5.8 M MA, and 0.64 M 1-octene;

FIG. 4 illustrates GPC traces of poly(methyl acrylate-co-ethene) (right) and poly[(methyl acrylate-co-ethene)-b-(methyl acrylate-co-propene)] (left) formed by sequential copper-mediated polymerization stages;

FIG. 5 is a MALDI-mass spectrum of a low molecular weight copolymer of methyl acrylate and norbornene synthesized in accordance with the invention using a 1:1 monomer ratio;

FIG. 6 is a graphical representation illustrating the dependence of molecular weight, Mₙ, and molecular weight distribution, M_{w}/Mₙ, on total monomer conversion for a low molecular weight copolymer synthesized by the copper-mediated copolymerization of methyl acrylate with norbornene, wherein the polymerization was performed at 90° C. in anisole (134.3 mmol), using 0.77 mmol CuBr, 0.77 mmol PMDETA, 0.77 mmol MBP, 44.4 mmol MA, and 44.8 mmol norbornene.

### DETAILED DESCRIPTION OF THE INVENTION

The copper-mediated process of the present invention is based on a similar procedure that is used with other non copper-based catalyst systems for the polymerization of methyl acrylate by atom transfer radical polymerization. In that procedure, a rapid equilibrium between active radicals and dormant halide end chains ensues. Numerous reports documenting the atom transfer radical polymerization of various monomers, including acrylates, have appeared in the literature. See, e.g., Matyjaszewski, Chem. Rev. 2001, 101, 2921; Kamigaito et al, Chem. Rev. 2001, 101, 3689; Patten et al, Ace. Chem. Res. 1999, 32, 895; Matyjaszewski, Controlled Radical Polymerization, Matyjaszewski, K., Ed.; ACS Symp Ser. 1998, 685, 258; and Xia et al, Macromolecules, 1997, 30, 7697.

In the present process, the acrylate and olefin monomers are contacted with a copper-containing catalyst system, with or without the presence of an inert solvent, at temperature of from about 20 to about 150° C., and preferably from about 40 to about 110° C., e.g., 90° C., and for a period of from about 0.5 to about 50 hrs, to produce random copolymers containing from about 5 to about 50 mol % olefin comonomer incorporation. The materials obtained are true copolymers and are not simply mixtures of homopolymers, as was verified by running gel permeation chromatography (GPC) with both refractive index and UV detectors, the latter being more sensitive to the acrylate groups. The copolymers obtained are characterized by having a low polydispersity, i.e., less than about 1.7, and typically less than about 1.6, and preferably less than about 1.5, for example, from about 1.1 to about 1.4.

The reactions can be carried out either in bulk or in solution. Solvents or diluents may be aromatic liquids, e.g., anisole, toluene, benzene, diphenyl ether or the like, as well as non-aromatic liquids, e.g., ethylene carbonate, ethyl acetate, DMF, alcohol, and water.

The acrylates that may be copolymerized in accordance with the present invention include alkyl or aryl acrylates, hydroxyethyl acrylate, alkyl and aryl methacrylates, or mixtures thereof, with methyl acrylate (MA) and methyl methacrylate (MMA) being preferred. Methyl acrylate is the most preferred acrylate monomer for use with the present invention.

The olefins that are contemplated for use in the present invention include linear and branched, non-polar olefins having from 2 to about 18 carbon atoms. Examples of suitable olefins include ethene, propene, 1-butene, 1-hexene, 1-octene, 1-decene, norbornene, norbornene derivatives such as 5-n-butyl-2-norbornene, 5-methylene-2-norbornene and 5-ethyl ester-2-norbornene, and mixtures thereof. Preferred olefins include ethene, propene, 1-butene, 1-hexene, 1-octene and norbornene.

The copper-containing catalyst system that is suitable for use in the present generally comprises a copper-containing component, a halogen-containing initiator component, and a nitrogen-containing ligand component.

The copper-containing component typically comprises a copper halide or pseudohalide and my be selected from, e.g., CuBr, CuCl, and CuCN and mixtures thereof.

The halide-containing initiator component typically comprises a benzyl halide, haloketone or haloester and may be selected from, e.g., methyl 2-bromopropionate (MBP), ethyl 2-bromopropionate (EBP), methyl 2-bromoisobutyrate (MBiB), ethyl 2-bromoisobutyrate (EbiB), and mixtures thereof.

The nitrogen-containing ligand component typically comprises an aliphatic, aromatic, or heterocyclic amine and may be selected from, e.g., N,N,N′,N′,N″-pentamethyldiethylenetriamine (PMDETA), 1,1,4,7,10,10-hexamethyltriethylenetetraamine HMTETA), bipyridine, tetramethylethylenediamine, and mixtures thereof.

A preferred copper-containing catalyst system comprises a mixture of copper bromide (CuBr), ethyl 2-bromopropionate (EBP) and N,N,N′,N′,N″-pentamethyldiethylenetriamine (PMDETA) in a molar ratio range of 1:0.25-3:0.25-3. Typically, the mole ratio of CuBr:EBP:PMDETA would be about 1:1:1.

The invention will be appreciated more fully when viewed in conjunction with the following illustrative examples.

### EXAMPLE 1

### Copolymerization of Methyl Acrylate with Ethene

In a drybox, CuBr (0.23 mmol), ethyl 2-bromopropionate (EBP; 0.23 mmol), N,N,N′,N′,N″-pentamethyldiethylenetriamine (PMDETA; 0.23 mmol), and methyl acrylate (5 g) were placed in an autoclave and stirred until the solution became homogeneous. The autoclave was sealed and removed from the drybox. Ethene (900 psi) was then pumped into the autoclave and the contents of the autoclave were heated to 90° C. After stirring the heated contents of the autoclave for 16 hrs, the autoclave was cooled to room temperature. The crude product was dissolved in CHCl₃ and purified by filtration through alumina to remove the metal compound. The solvent was removed and the product was dried under vacuum to yield 1.5 g. The copolymer product contained 8.6 mol % ethene, had a molecular weight (Mₙ) of 10,400, determined by GPC relative to polystyrene standards using a refractive index detector, and a polydispersity (M_{w}/Mₙ) of 1.5, determined by GPC relative to polystyrene standards using a refractive index detector. The results of this example are set forth in Table 1.

### EXAMPLE 2

### Copolymerization of Methyl Acrylate with Ethene

The procedure of Example 1 was repeated, except that 1.4 mmol of CuBr, 1.4 mmol of EBP, and 1.4 mmol of PMDETA were used with 5 g. of MA and ethene 900 psi. The random copolymer product (4.5 g.) contained 14.8 mol % ethene. The molecular weight (Mₙ) and polydispersity (Md_{w}/Mₙ) were not determined. The results of this example are summarized in Table 1.

### EXAMPLE 3

### Copolymerization of Methyl Acrylate with Propene

The procedure of Example 1 was repeated, except that 0.47 mmol of CuBr, 0.47 mmol of EBP, and 0.47 mmol of PMDETA were used. Also, 17.0 g. of propene was introduced into the reactor (a round bottom flask) in place of the ethene. The copolymer product (3.8 g.) contained 21.7 mol % propene, had a molecular weight (Mₙ) of 9,900 (determined by GPC relative to polystyrene standards using a refractive index detector), and a polydispersity (M_{w}/Mₙ) of 1.4 (determined by GPC relative to polystyrene standards using a refractive index detector). A ¹³C DEPT NMR spectrum of the methyl acrylate-propene copolymer was used to determine the chemical shift assignments of the backbone carbons for the triad sequences (FIG. 2). The corresponding chemical shift values also were calculated empirically. The results of this example are summarized in Tables 1 and 3.

### EXAMPLE 4

### Copolymerization of Methyl Acrylate with 1-Butene

The procedure of Example 3 was repeated, except 4.2 g. of 1-butene was substituted for the propene. In addition, the molecular weight and polydispersity of the copolymer product were determined by GPC relative to polystyrene standards using both a refractive index detector and a UV detector. The copolymer product (4.5 g.) contained 7.8 mol % 1-butene, had a molecular weight (Mₙ) of 9,300 using a refractive index detector (8,100 using a UV detector) and a polydispersity (M_{w}/Mₙ) of 1.3 using a refractive index detector (1.4 using a UV detector). The results of this example are summarized in Table 1.

### EXAMPLE 5

### Copolymerization of Methyl Acrylate with 1-Hexene

The procedure of Example 3 was repeated, except 3.0 g. of 1-hexene was substituted for the propene. The copolymer product (4.3 g.) contained 11.8 mol % 1-hexene, had a molecular weight (Mₙ) of 12,000, and a polydispersity (M_{w}/Mₙ) of 1.3. The results of this example are summarized in Table 1.

### EXAMPLE 6

### Copolymerization of Methyl Acrylate with 1-Hexene

The procedure of Example 3 was repeated, except that 3.0 g. of MA was used instead of 5.0 g. of MA, and that 6.0 g 1-hexene was substituted for the propene. The copolymer product (2.5 g.) contained 21.3 mol % 1-hexene, had a molecular weight (Mₙ) of 5,800, and a polydispersity (M_{w}/Mₙ) of 1.3. The results of this example are summarized in Table 1.

### EXAMPLE 7

### Copolymerization of Methyl Acrylate with 1-Octene

The procedure of Example 3 was repeated, except that 3.0 g. of MA was used instead of 5.0 g. of MA, and that 7.8 g. of 1-octene was substituted for the propene. The copolymer product (3.0 g.) contained 23.6 mol % 1-octene, had a molecular weight (Mₙ) of 12,000, and a polydispersity (M_{w}/Mₙ) of 1.2. The results of this example are summarized in Table 1.

TABLE 1
Copper-mediated copolymerization of methyl acrylate with olefins^{a}

| | | | | olefin | | |
|---|---|---|---|---|---|---|
| | MA | olefin | Yield | incorp. | | |
| Example | (g) | (g) | (g) | (mol %) | Mₙ^{b} | M_{w}/Mₙ^{b} |
| 1^{c} | 5.0 | ethene, 900 psi | 1.5 | 8.6 | 10,400 | 1.5 |
| 2^{d} | 5.0 | ethene, 900 psi | 4.5 | 14.8 | n.d. | n.d. |
| 3 | 5.0 | propene, 17.0 g | 3.8 | 21.7 | 9,900 | 1.4 |
| 4 | 5.0 | 1-butene, 4.2 g | 4.5 | 7.8 | 9,300 | 1.3 |
| | | | | | (8,100)^{e} | (1.4)^{e} |
| 5 | 5.0 | 1-hexene, 3.0 g | 4.3 | 11.8 | 12,000 | 1.3 |
| 6 | 3.0 | 1-hexene, 6.0 g | 2.5 | 21.3 | 5,800 | 1.3 |
| 7 | 3.0 | 1-octene, 7.8 g | 3.0 | 23.6 | 4,000 | 1.2 |

^{a}Reaction conditions, unless noted otherwise: CuBr, 0.47 mmol; ethyl 2-bromopropionate (EBP), 0.47 mmol; pentamethyldiethylenetriamine (PMDETA), 0.47 mmol; 90° C.; 16 h.
^{b}Determined by GPC relative to polystyrene standards using refractive index detector.
^{c}CuBr, 0.23 mmol; EBP, 0.23 mmol; PMDETA, 0.23 mmol.
^{d}CuBr, 1.4 mmol; EBP, 1.4 mmol; PMDETA, 1.4 mmol.
^{e}using UV detector

### COMPARATIVE EXAMPLE C1

### AIBN-Initiated Copolymerization of Methyl Acrylate with Ethene

In a drybox, azobis(isobutyronitrile) (AIBN (0.03 mmol), chlorobenzene (PhCl; 4 ml), and methyl acrylate (1.9 g) were placed in an autoclave and stirred until the solution became homogeneous. The autoclave was sealed and removed from the drybox. Ethene (500 psi) was then pumped into the autoclave and the contents of the autoclave were heated to 60° C. After stirring the heated contents of the autoclave for 21 hrs, the autoclave was cooled to room temperature. The crude product was dissolved in CHCl₃ and purified by filtration. The solvent was removed and the product was dried under vacuum. The copolymer product (1.6 g.) contained 5.7 mol % ethene, had a molecular weight (Mₙ) of 284,000, determined by GPC relative to polystyrene standards using a refractive index detector, and a polydispersity (M_{w}/Mₙ) of 9.0, determined by GPC relative to polystyrene standards using a refractive index detector. The results of this example are summarized in Table 2.

### COMPARATIVE EXAMPLE C2

### AIBN-Initiated Copolymerization of Methyl Acrylate with Propene

The procedure of Example C1 was repeated, except that 5.3 g. of propene was introduced into the reactor (a round bottom flask) in place of the ethene. the copolymer product (1.0 g.) contained 21.5 mol % propene, had a molecular weight (Mₙ) of 451,000 (determined by GPC relative to polystyrene standards using a refractive index detector), and a polydispersity (M_{w}/Mₙ) of 2.0 (determined by GPC relative to polystyrene standards using a refractive index detector). The results of this example are summarized in Table 2.

### COMPARATIVE EXAMPLE C3

### AIBN-Initiated Copolymerization of Methyl Acrylate with 1-Hexene

The procedure of Example C2 was repeated, except that 1.8 g. of MA was used instead of 1.9 g. of MA, and that 0.2 g. of 1-hexene was substituted for the propene. The copolymer product (1.7 g.) contained 3.4 mol % 1-octene, had a molecular weight (Mₙ) of 320,000, determined by GPC relative to polystyrene standards using a refractive index detector (254,000, determined using a UV detector) and a polydispersity (M_{w}/Mₙ) of 2.9, determined by GPC relative to polystyrene standards using a refractive index detector (3.1, determined using a UV detector). The results of this example are summarized in Table 2.

### COMPARATIVE EXAMPLE C4

### AIBN-Initiated Copolymerization of Methyl Acrylate with 1-Hexene

The procedure of Example C3 was repeated, except that 1.0 g. of MA was used instead of 1.8 g. of MA, and that 1.0 g. of 1-hexene was used instead of 0.2 g of 1-hexene. The copolymer product (0.5 g.) contained 11.6 mol % 1-hexene, had a molecular weight (Mₙ) of 161,000, determined by GPC relative to polystyrene standards using a refractive index detector, and a polydispersity (M_{w}/Mₙ) of 1.7, determined by GPC relative to polystyrene standards using a refractive index detector. The results of this example are summarized in Table 2.

### COMPARATIVE EXAMPLE C5

### AIBN-Initiated Copolymerization of Methyl Acrylate with 1-Hexene

The procedure of Example C3 was repeated, except that 0.9 g. of MA was used instead of 1.8 g. of MA, and that 1.1 g. of 1-hexene was used instead of 0.2 g of 1-hexene. The copolymer product (0.3 g.) contained 13.7 mol % 1-hexene, had a molecular weight (Mₙ) of 140,000, determined by GPC relative to polystyrene standards using a refractive index detector, and a polydispersity (M_{w}/Mₙ) of 1.6, determined by GPC relative to polystyrene standards using a refractive index detector. The results of this example are summarized in Table 2.

### COMPARATIVE EXAMPLE C6

### AIBN-Initiated Copolymerization of Methyl Acrylate with 1-Hexene

The procedure of Example C3 was repeated, except that 0.7 g. of MA was used instead of 1.8 g. of MA, and that 1.3 g. of 1-hexene was used instead of 0.2 g of 1-hexene. The copolymer product (0.2 g.) contained 17.9 mol % 1-hexene, had a molecular weight (Mₙ) of 154,000, determined by GPC relative to polystyrene standards using a refractive index detector, and a polydispersity (M_{w}/Mₙ) of 1.5, determined by GPC relative to polystyrene standards using a refractive index detector. The results of this example are summarized in Table 2.

### COMPARATIVE EXAMPLE C7

### AIBN-Initiated Copolymerization of Methyl Acrylate with 1-Octene

The procedure of Example C2 was repeated, except that 0.9 g. of MA was used instead of 1.9 g. of MA, and that 1.1 g. of 1-octene was substituted for the propene. The copolymer product (0.5 g.) contained 12.9 mol % 1-octene, had a molecular weight (Mₙ) of 115,000, determined by GPC relative to polystyrene standards using a refractive index detector (90,000, determined using a UV detector) and a polydispersity (M_{w}/Mₙ) of 1.6, determined by GPC relative to polystyrene standards using a refractive index detector (1.6, determined using a UV detector). The results of this example are summarized in Table 2.

TABLE 2
AIBN-initiated copolymerization of methyl acrylate with olefins^{a}

| | | | | olefin | | |
|---|---|---|---|---|---|---|
| | MA | olefin | Yield | incorp. | | M_{w}/ |
| Example | (g) | (g) | (g) | (mol %) | Mₙ^{b} | Mₙ^{b} |
| C1 | 1.9 | ethene, 500 psi | 1.6 | 5.7 | 284,000 | 9.0 |
| C2 | 1.9 | propene, 5.3 g | 1.0 | 21.5 | 451,000 | 2.0 |
| C3 | 1.8 | 1-hexene, 0.2 g | 1.7 | 3.4 | 320,000 | 2.9 |
| | | | | | (254,000)^{c} | (3.1)^{c} |
| C4 | 1.0 | 1-hexene, 1.0 g | 0.5 | 11.6 | 161,000 | 1.7 |
| C5 | 0.9 | 1-hexene, 1.1 g | 0.3 | 13.7 | 140,000 | 1.6 |
| C6 | 0.7 | 1-hexene, 1.3 g | 0.2 | 17.9 | 154,000 | 1.5 |
| C7 | 0.9 | 1-octene, 1.1 g | 0.5 | 12.9 | 115,000 | 1.6 |
| | | | | | (90,000)^{c} | (1.6)^{c} |

^{a}Reaction conditions: AIBN, 0.03 mmol; PhCl, 4 ml; 60° C.; 21 h.
^{b}Determined by GPC relative to polystyrene standards using refractive index detector, unless noted otherwise.
^{c}using UV detector.

By comparing Examples 1-7 (Table 1; copper-mediated copolymerization) with Examples C1-C7 (Table 2; AlBN-initiated copolymerization), it can be seen that similar, but slightly lower, amounts of olefin are present in the copolymer products prepared using AlBN initiation. On the other hand, copolymers prepared using AlBN initiation have significantly higher molecular weights and polydispersities.

In Example 4 (Table 1) and Comparative Example C3 (Table 2), the molecular weight and polydispersity of the respective polymer products were determined by gel permeation chromatography (GPC) using both refractive index and UV detectors (the latter being more sensitive to acrylate groups) to verify that the products were true copolymers, rather than simply mixtures of homopolymers. And, as shown in Tables 1 and 2, the molecular weight data obtained by the two GPC methods were in close agreement, implying that the materials were copolymers in which the concentration of the acrylate groups is independent of the molecular weight over the observed unimodal distribution. The formation of true copolymers was also shown by MALDI-mass spectra of copolymers of methyl acrylate with ethene, with 1-hexene, and with 1-octene.

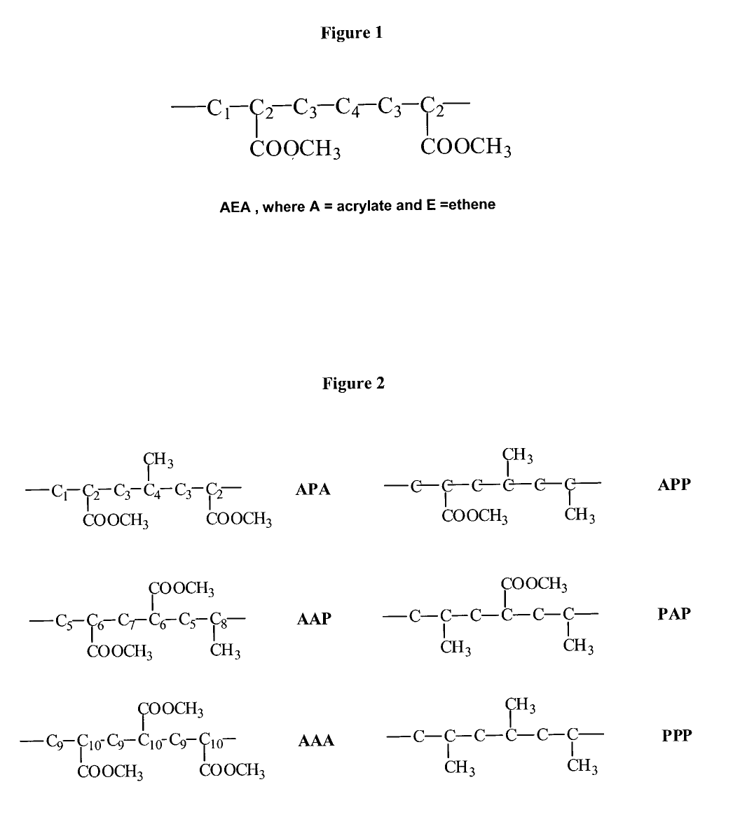

The random nature of the copolymers prepared in accordance with Examples 1-7 was verified by ¹H and ¹³C NMR spectroscopy. The relative simplicity of the ¹H and ¹³C NMR spectra suggests the presence of AAA and AOA sequences but not AOO or OAO sequences (A=acrylate, O=olefin). The ¹³C NMR spectrum for the methyl acrylate-ethene copolymer (Examples 1 and 2) showed resonances resulting from runs of acrylate units, 175.5 (—C(O)O), 51.8 (—OCH₃), 41.5 (—CH—), and 35.3 ppm (—CH₂—), as well as resonances at 176.5, 43.5 (C₂), 35.3 (br, C₁), 33.1, 32.4 (br, C₃) and 25.1 ppm (br, C₄), attributable to both the acrylate-ethene-acrylate and acrylate-acrylate-ethene sequences (FIG. 1). The peak at 43.5 ppm suggests a random copolymer since this resonance would be absent in the ¹³C NMR spectrum of an alternating copolymer made by free radical polymerisation in the presence of a Lewis acid, as described, for example, in Logothetis et al, J. Polym. Sci.: Poly. Chem. Ed., 1978, 16, 2797. The copolymer products prepared in accordance with Examples 1-7 also showed minor resonances at 173.3 (—C(O)O), 60.7 (—OCH₂CH₃), 37.3 (—CHCH₃), 18.3 (—CHCH₃) and 14.3 ppm (—OCH₂CH₃) due to end groups derived from the ethyl bromopropionate (EBP) initiator.

With reference to Table 3, it can be seen that the observed values for the ¹³C DEPT NMR spectrum chemical shift assignments of the backbone carbons for the triad sequences of the MA-propene copolymer prepared in Example 3, are very close to the calculated values. Given this close agreement, it is clear that the observed chemical shifts correspond to the APA, AAP and AAA sequences (A=acrylate, P=propene), and that the APP, PAP, and PPP sequences are absent. In addition to the resonances shown in Table 3, the MA-propene copolymer also showed minor resonances at 173.3 (—C(O)O), 60.7 (—OCH₂CH₃), 37.3 (—CHCH₃), 18.3 (—CHCH₃) and 14.3 ppm (—OCH₂CH₃) due to end groups derived from the ethyl bromopropionate (EBP) initiator. This was further verified by a comparison with the ¹³C NMR spectrum of a methyl acrylate homopolymer made by the same copper-mediated procedure.

TABLE 3
Chemical shift assignments for the backbone carbons
in triad sequences of methyl acrylate-propene copolymer.

| Triad sequence | Backbone | Calcd. Shift | Obsvd. Shift |
|---|---|---|---|
| from FIG. 2^{a} | carbon | (ppm) | (ppm) |
| APA | 1 | 35.2 | 35.3 |
| APA | 2 | 40.8 | overlapping |
| APA | 3 | 39.8 | 39.9 |
| APA | 4 | 28.6 | 29.2 |
| AAP | 5 | 39.8 | 39.9 |
| AAP | 6 | 40.8 | overlapping |
| AAP | 7 | 35.2 | 35.3 |
| AAP | 8 | 28.6 | 29.2 |
| AAA | 9 | 35.2 | 35.3 |
| AAA | 10 | 41.4 | 41.2 |

^{a}A = acrylate, P = propene

### EXAMPLE 8

### Copolymerization of Methyl Acrylate with Norbornene

In a drybox, CuBr (0.055 g, 0.38 mmol), N,N,N′,N′,N″-pentamethyldiethylenetriamine (PMDETA; 0.080 mL. 0.38 mmol), methyl acrylate (1.78 mL, 19.7 mmol) and norbornene (1.80 g, 19.1 mmol) were placed in a round bottom flask and stirred until the solution became homogeneous. Methyl 2-bromopropionate (MBP; 0.064 g, 0.38 mmol) was then added to the flask. The flask was then capped with a rubber septum and removed from the drybox. After stirring for 21 hrs at 90 ° C. , the flask was cooled to room temperature. The crude product was dissolved in CHCl₃ and purified by filtration through alumina to remove the metal compound. The solvent was removed and the product was dried under vacuum to yield 1.3 g (37%, based on total monomer feed). The copolymer product was determined to comprise a mole ratio of 1:0.26 methyl acrylate:norbornene, ¹H and ¹³C NMR spectroscopy was used to establish the random nature of the copolymers formed. The ¹H NMR spectrum (CDCl₃) (ppm) showed the following: 3.68 (s, br), 2.5−0.71 (m, br). ¹³C{¹H} NMR (CDCl₃) (ppm): 176.5−175.1, 175.0, 51.8, 48.8, 46.5, 43.0, 41.4, 40.0−33.8, 31.1−29.5, 28.7. 21.7. The copolymer had a molecular weight (Mₙ) of 2,600, determined by GPC relative to polystyrene standards using a refractive index detector, and a polydispersity (M_{w}/Mₙ) of 1.4. The MALDI-mass spectrum of the copolymer product is shown in FIG. 5 and the results of this example are summarized in Table 4.

### EXAMPLE 9

### Copolymerization of Methyl Acrylate with Norbornene

The procedure of Example 10 was repeated, except that 38.4 mmol methyl acrylate was copolymerised with 38.2 mmol norbornene. The copolymer product was determined to comprise a mole ratio 1:0.25 methyl acrylate:norbornene. The copolymer had a molecular weight (Mₙ) of 7,500 and a polydispersity of 1.7. The results of this example are summarized in Table 4.

### EXAMPLE 10

### Copolymerization of Methyl Acrylate with Norbornene

The procedure of Example 10 was repeated, except that 76.7 mmol methyl acrylate was copolymerised with 76.4 mmol norbornene. The copolymer product was determined to comprise a mole ratio 1:0.21 methyl acrylate:norbornene. The copolymer had a molecular weight (Mₙ) of 11,700 and a polydispersity of 1.7. The results of this example are summarized in Table 4.

### EXAMPLE 11-15

### Copolymerization of Methyl Acrylate with Norbornene

In a series of examples, the procedure of Example 10 was followed, except that the mole ratios of the respective monomers and catalysts components were modified as indicated in Table 4. The results of these examples are summarized in Table 4.

### EXAMPLE 16

### Homopolymerization of Methyl Acrylate

CuBr (0.055 g, 0.38 mmol), PMDETA (0.080 mL, 0.38 mmol), EBP (0.050 mL, 0.38 mmol) and methyl acrylate (2.00 mL, 22.2 mmol) were placed in a round bottom flask. The flask was capped with a rubber septum and removed from the drybox. After stirring for 15 hr at 90° C., the flask was cooled to room temperature. The crude product was dissolved in CHCl₃ and purified by filtration through alumina to remove the metal compound. The solvent was removed and the product was dried under vacuum overnight to yield 1.9 g (99% conversion). The copolymer had a molecular weight (Mₙ) of 4,800, determined by GPC relative to polystyrene standards using a refractive index detector, and a polydispersity (M_{w}/Mₙ) of 1.1. The results of this example are summarized in Table 4.

### EXAMPLE 17

### Attempted Homopolymerization of Norbornene

The procedure of Example 16 was followed, except that the methyl acrylate was replaced with norbornene (2.00 g, 21.2 mmol). The norbornene polymerised only to a small extent, yielding only 0.1 g of polymer (5% conversion). The results of this example are summarized in Table 4.

TABLE 4
Copolymerization of methyl acrylate (MA) and norbornene (NB)^{a}

| | | | | | Polymer | | |
|---|---|---|---|---|---|---|---|
| | MA | NB | | Yield | Composition^{b} | | M_{w}/ |
| | (mmol) | (mmol) | MA:NB | (%) | MA:NB | Mₙ^{c} | Mₙ^{c} |
| 8 | 19.8^{d} | 19.1 | 1:1 | 37 | 1:0.26 | 2,600 | 1.4 |
| 9 | 38.4^{d} | 38.2 | 1:1 | 43 | 1:0.25 | 7,500 | 1.7 |
| 10 | 76.7^{d} | 76.4 | 1:1 | 23 | 1:0.21 | 11,700 | 1.7 |
| 11 | 21.0 | 2.2 | 10:1 | 75 | PMA | 5,900 | 1.2 |
| 12 | 19.0 | 3.8 | 5:1 | 60 | PMA | n.d. | n.d. |
| 13 | 11.2 | 11.2 | 1:1 | 45 | 1:0.28 | 2,400 | 1.2 |
| 14 | 41.8^{e} | 41.4 | 1:1 | 35 | 1:0.24 | 9,200 | 1.6 |
| 15 | 7.6 | 14.9 | 0.5:1 | 35 | 1:0.46 | 1,700 | 1.2 |
| 16 | 22.2 | — | — | 95 | PMA | 4,800 | 1.1 |
| 17 | — | 21.2 | — | 5 | PNB | — | — |

^{a}Reaction conditions: CuBr, 0.38 mmol, EBP, 0.38 mmol, PMDETA, 0.38 mmol; total monomer (MA + NB), 2.0 g; 90° C., 15 hr.
^{b}Determined by ¹H NMR integration.
^{c}Determined by SEC in CHCl₃ relative to poly(styrene).
^{d}21 h.
^{e}Total monomer, 7.5 g.

With reference to Table 4, it can be seen that methyl acrylate readily hompolymerized, with almost complete conversion, when using the copper-mediated polymerisation of the present invention; whereas, norbornene was homopolymerized only to the extent of about 5% conversion. The data in Table 4 also shows that higher molecular weight copolymers were achieved using a higher monomer to initiator ratio (Example 8-10, 14); and that at higher methyl acrylate to norbornene feed ratios, essentially pure poly(methyl acrylate) was formed (Examples 11, 12 and 16). On the other hand, the relative amount of norbornene incorporated into the copolymer increased with increasing norbornene feed ratios (Examples 14 and 15), whereas only an insignificant conversion to homopolymer was obtained when norbornene was used as the sole monomer (Example 17).

### EXAMPLE 18

### Copolymerization of Methyl Acrylate with 5-n-Butyl-2-Norbornene

The procedure of Example 8 was followed, except that methyl acrylate (1.57 mL, 17.4 mmol) and n-butyl norbornene (2.60 g, 17.3 mmol) were employed to yield 2.2 g of copolymer (54% conversion, based on total monomer feed). The copolymer product was determined to comprise a mole ratio of 1:0.27 methyl acrylate:5-n-butyl-2-norbornene. The ¹H NMR spectrum (CDCl₃) (ppm) showed the following: 3.67 (s, br), 2.66−0.33 (m, br). ¹³C{¹H} NMR (CDCl₃) (ppm): 175.4−175.0, 52.0−51.5, 41.8−41.3, 40.5−32.7, 31.2, 23.1, 14.4. The copolymer had a molecular weight (Mₙ) of 2,400, determined by GPC relative to polystyrene standards using a refractive index detector, and a polydispersity (M_{w}/Mₙ) of 1.4. The results of this example are summarized in Table 5.

### EXAMPLE 19

### Copolymerization of Methyl Acrylate with 5-n-Butyl-2-Norbornene

The procedure of Example 18 was followed, except that 41.9 mmol of methyl acrylate, 42.0 mmol of 5-n-butyl-2-norbornene were used, and that catalyst system comprised CuBr (0.21 mmol), N,N,N′,N′,N″-pentamethyldiethylenetriamine (PMDETA; 0.21 mmol) and MBP (0.21 mmol). The conversion copolymer was 32%, based on total monomer feed, and the copolymer product was determined to comprise a mole ratio 1:0.23 methyl acrylate:5-n-butyl-2-norbornene. The copolymer had a molecular weight (Mₙ) of 16,100 and a polydispersity of 1.7. The results of this example are summarized in Table 5.

### EXAMPLE 20

### Copolymerization of Methyl Acrylate with 5-Methylene-2-Norbornene

The procedure of Example 18 was followed, except that methyl acrylate (1.88 mL, 20.9 mmol) and 5-methylene-2-norbornene (2.34 mL, 21.7 mmol) were employed to yield 1.6 g (39% conversion based on total monomer feed). The copolymer product was determined to comprise a mole ratio 1:0.63 methyl acrylate:5-methylene-2-norbornene. The ¹H NMR spectrum (CDCl₃) (ppm) showed the following: 3.68 (s, br), 2.84−0.57 (m, br). The copolymer had a molecular weight (Mₙ) of 2,200 and a polydispersity of 1.6. The results of this example are summarized in Table 5.

### EXAMPLE 21

### Copolymerization of Methyl Acrylate with 5-Ethyl Ester-2-Norbornene

The procedure of Example 18 was followed, except that methyl acrylate (1.46 mL, 16.3 mmol) and 5-ethyl ester-2-norbornene (2.7 g, 16.2 mmol) were employed to yield 1.0 g (25% conversion based on total monomer feed). The copolymer product was determined to comprise a mole ratio 1:0.22 methyl acrylate:5-ethyl ester-2-norbornene. The ¹H NMR spectrum (CDCl₃) (ppm) showed the following: 4.08 (m, br), 3.61 (s, br), 2.90−0.79 (m, br). The copolymer had a molecular weight (Mₙ) of 1,300 and a polydispersity of 1.3. The results of this example are summarized in Table 5.

TABLE 5
Copolymerization of methyl acrylate (MA) and norbornene derivatives^{a}

| | | | | Polymer | | |
|---|---|---|---|---|---|---|
| | MA | Comonomer | Yield | composition^{b} | | |
| Example | (mmol) | (mmol) | (%) | (MA:comonomer) | Mₙ^{c} | M_{w}/Mₙ^{c} |
| 18 | 17.4 | 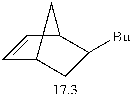 | 54 | 1:0.27 | 2,400 | 1.4 |
| 19 | 41.9^{d} | 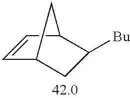 | 32 | 1:0.23 | 16,100 | 1.7 |
| 20 | 20.9 | 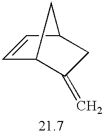 | 39 | 1:0.63 | 2,200 | 1.6 |
| 21 | 16.3 | 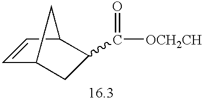 | 25 | 1:0.22 | 1,300 | 1.3 |

^{a}Reaction conditions: CuBr, 0.38 mmol; MBP, 0.38 mmol; PMDETA, 0.38 mmol; 90-95° C., 21 hr.
^{b}Determined by ¹H NMR integration.
^{c}Determined by SEC in CHCl₃ relative to poly(styrene).
^{d}CuBr 0.21 mmol; MBP, 0.21 mmol; PMDETA, 0.21 mmol.

### COMPARATIVE EXAMPLE C8

### AIBN-Initiated Copolymerization of Methyl Acrylate with Norbornene

A solution of AIBN (0.05 g, 0.03 mmol) in PhCl (2 mL) was placed in a round bottom flask equipped with a magnetic stirrer. A solution of methyl acrylate (1.04 mL, 11.6 mmol) and norbornene (1.00 g, 10.6 mmol) in PhCl (2 mL) was added to the flask. The flask was capped with a rubber septum and removed from the drybox. After stirring for 21 hr at 60° C., the flask was cooled to room temperature. The polymer was precipitated from MeOH, the MeOH was decanted and the polymer was dried under vacuum to yield 1.0 g (50% conversion, based on total monomer feed). The copolymer product was determined to comprise a mole ratio 1:0.32 methyl acrylate:norbornene. The ¹H NMR spectrum (CDCl₃) (ppm) showed: 3.67 (s, br), 2.59−0.72 (m, br). The copolymer had a molecular weight (Mₙ) of 45,800 and a polydispersity of 2.0. The results of this example are summarized in Table 6.

### COMPARATIVE EXAMPLE C9

### AIBN-Initiated Copolymerization of Methyl Acrylate with 5-n-Butyl-2-norbornene

The procedure of Example C8 was repeated, except that methyl acrylate (0.73 mL, 8.1 mmol) and 5-n-butyl-2-norbornene (1.3 g, 8.7 mmol) were employed to yield 0.8 g (40% conversion based on total monomer feed). The copolymer product was determined to comprise a mole ratio 1:0.29 methyl acrylate:5-n-butyl-2-norbornene. The ¹H NMR spectrum (CDCl₃) (ppm) showed: 3.68 (s, br), 2.63−0.43 (m, br). The copolymer had a molecular weight (Mₙ) of 45,900 and a polydispersity of 1.9. The results of this example are summarized in Table 6.

### COMPARATIVE EXAMPLE C10

### AIBN-Initiated Copolymerization of Methyl Acrylate with 5-Methylene-2-norbornene

The procedure of Example C8 was repeated, except that methyl acrylate (0.94 mL, 10.05 mmol) and 5-methylene-2-norbornene (1.12 mL, 10.4 mmol) were employed to yield 1.3 g (65% conversion based on total monomer feed). The copolymer product was insoluble and therefore, the molecular weight and polydispersity were not determined. The results of this example are summarized in Table 6.

### COMPARATIVE EXAMPLE 11

### AIBN-Initiated Copolymerization of Methyl Acrylate with 5-Ethyl Ester1-2-norbornene

The procedure of Example C8 was repeated, except that methyl acrylate (0.67 ml, 7.0 mmol) and 5-ethyl ester-2-norbornene (1.3 g, 7.8 mmol) were employed to yield 0.5 g (26.3% conversion based on total monomer feed). The copolymer product was determined to comprise a mole ratio 1:0.24 methyl acrylate:5-ehtyl ester-2-norbornene. The ¹H NMR spectrum (CDCl₃) (ppm) showed: 4.13 (m, br), 3.67 (s, br), 2.84−0.78 (m, br). The copolymer had a molecular weight (Mₙ) of 47,600 and a polydispersity of 1.6. The results of this example are summarized in Table 6.

A comparison of the data shown in Tables 5 and 6 indicates that the use of the present copper-based catalyst system results in copolymers having a lower molecular weight and a lower polydispersity than copolymers prepared from the same monomers when using 2,2-azobis(isobutyronitrile) (AIBN) as the initiator. This would be expected, inasmuch as AIBN-initiated copolymerisation is generally considered to be an uncontrolled polymerisation system. It will also be noted that the AIBN-initiated copolymerisation of methyl acrylate with 5-methylene-2-norbornene resulted in an insoluble, cross-linked material (Table 6, Example C10), whereas the copolymerisation of methyl acrylate with 5-methylene-2-norbornene using the present copper-based catalyst system resulted in a copolymer having a molecular weight of 2,200 and a polydispersity of 1.6 (Table 5, Example 20). The copolymers of Examples 18-21 (having a feed ratio of methyl acrylate:norbornene of 1:1) were characterized by size exclusion chromatography (SEC), NMR spectroscopy, and mass spectrometry. SEC showed unimodal distributions, implying that the polymers are copolymers rather than a mixture of homopolymers. The MALDI-MS spectra of methyl acrylate/norbornene (FIG. 5) shows that the molecular masses of individual polymer chains differ by either an acrylate or norbornene unit, suggesting the formation of copolymers rather than mixtures of homopolymers.

TABLE 6
AIBN-initiated copolymerization of methyl acrylate (MA) and norbornene derivatives^{a}

| | | | | Polymer | | |
|---|---|---|---|---|---|---|
| | MA | Comonomer | Yield | composition^{b} | | |
| Example | (mmol) | (mmol) | (%) | (MA:comonomer) | Mₙ^{c} | M_{w}/Mₙ^{c} |
| C8 | 11.6 | 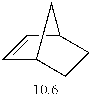 | 50 | 1:0.32 | 45,800 | 2.0 |
| C9 | 8.1 | 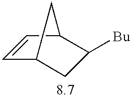 | 40 | 1:0.29 | 45,900 | 1.9 |
| C10 | 10.5 | 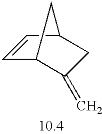 | 65 | insoluble | n.d. | n.d. |
| C11 | 7.0 | 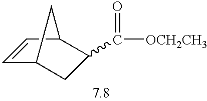 | 26 | 1:0.24 | 47,600 | 1.6 |

^{a}Reaction conditions: AIBN, 0.03 mmol; PhCl, 4 ml; 60° C., 21 hr.
^{b}Determined by ¹H NMR integration.
^{c}Determined by SEC in CHCl₃ relative to poly(styrene).

### EXAMPLE 22

### Data for the Plot of Molecular Weight Versus Conversion for Copolymerization of Methyl Acrylate with Norbornene

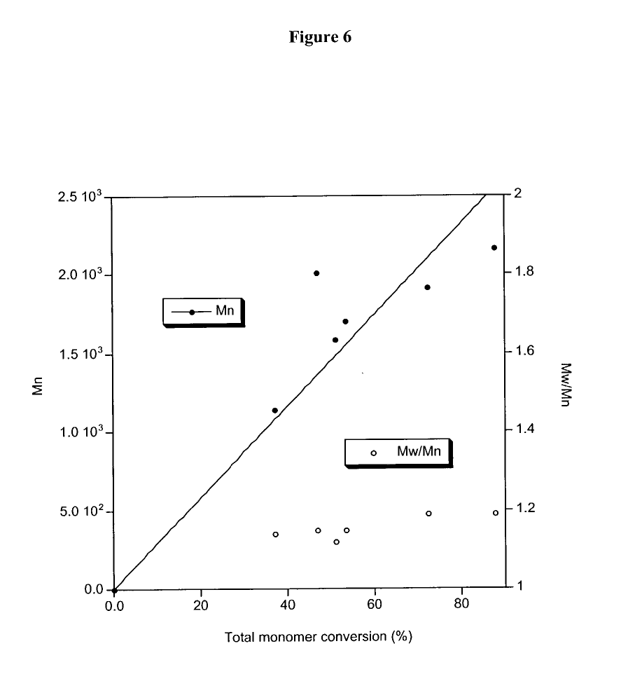

In a drybox, CuBr (0.11 g, 0.77 mmol), PMDETA (0.16 mL, 0.77 mmol), anisole (14.60 mL, 134.3 mmol), methyl acrylate (4.00 mL, 44.4 mmol) and norbornene (4.20 g, 44.8 mmol) were placed in a round bottom flask. The solution was allowed to stir until it became homogeneous. MBP (0.127 g, 0.77 mmol) was then added to the flask. The flask was capped with a rubber septum and removed from the drybox. The reaction mixture was stirred at 90° C. Under a nitrogen flow, aliquots were taken from the reaction mixture at the desired reaction times. The samples were dissolved in CHCl₃ and purified by filtration through alumina to remove the metal compound. The solvent was removed and the products were dried under vacuum. The molecular weight, polydispersity and conversion were determined for each aliquot. The results of this example are shown graphically in FIG. 6.

### EXAMPLE 23

### Copolymerization of Methyl Acrylate with Norbornene

The procedure of Example 11 was repeated, except that 24.4 mmol methyl acrylate was copolymerised with 22.3 mmol norbornene. The copolymer product was determined to comprise a mole ratio 1:0.25 methyl acrylate:norbornene. The copolymer had a molecular weight (Mₙ) of 2,700 and a polydispersity of 1.3, and the yield was 40% (based on total monomer feed). The results of this example are summarized in Table 7.

### EXAMPLE 24

### Copolymerization of Methyl Acrylate with Norbornene

The procedure of Example 11 was repeated, except that the mole ratio of PMDETA:CuBr was changed from 1:1 to 5:1. The copolymer product was determined to comprise a mole ratio 1:0.23 methyl acrylate:norbornene. The copolymer had a molecular weight (Mₙ) of 2,000 and a polydispersity of 1.3, and the yield was 36%. The results of this example are summarized in Table 7.

### EXAMPLE 25

### Copolymerization of Methyl Acrylate with Norbornene

The procedure of Example 11 was repeated, except that the mole ratio of PMDETA:CuBr was changed from 1:1 to 10:1. The copolymer product was determined to comprise a mole ratio 1:0.20 methyl acrylate:norbornene. The copolymer had a molecular weight (Mₙ) of 1,900 and a polydispersity of 1.4, and the yield was 29%. The results of this example are summarized in Table 7.

TABLE 7

Effect of ligand: Cu ratio on the copolymerization of methyl acrylate and norbornene^{a}

| | | | | | Polymer | | |
|---|---|---|---|---|---|---|---|
| | MA | NB | | Yield | composition^{b} | | |
| Example | (mmol) | (mmol) | PMDETA:CuBr | (%) | (MA:NB) | Mₙ^{c} | M_{w}/Mₙ^{c} |
| 23 | 24.4 | 22.3 | 1:1 | 40 | 1:0.25 | 2,700 | 1.3 |
| 24 | 24.4 | 22.3 | 5:1 | 36 | 1:0.23 | 2,000 | 1.3 |
| 25 | 24.4 | 22.3 | 10:1 | 29 | 1:0.20 | 1,900 | 1.4 |

^{a}Reaction conditions: CuBr, 0.38 mmol, PMDETA, 0.38 mmol, MBP, 0.38 mmol, 92° C., 21 hr.
^{b}Determined by ¹H NMR integration.
^{c}Determined by SEC in CHCl₃ relative to poly(styrene).

With reference to Table 7, it can be seen that varying the ratio of nitrogen-containing ligand component to copper component (1:1, 5:1, and 10:1) had little effect on the copolymerisation reaction.

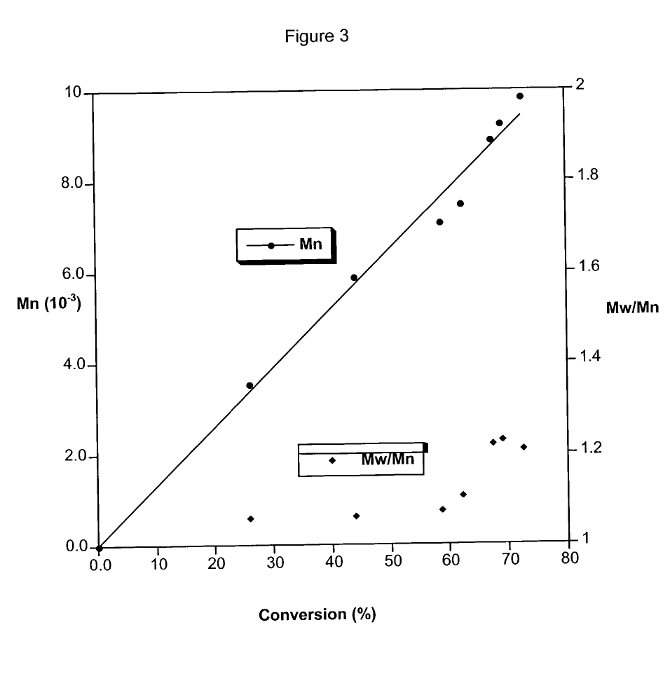

In a further aspect of the invention, it has been discovered that the present copper-mediated copolymerization process displays many of the characteristics of a living polymerization system. As shown in FIG. 3, the molecular weight of the methyl acrylate-1-octene copolymer, prepared at 90° C. in anisole in accordance with the general procedure of Example 7, (using 0.04 M CuBr, 0.04 M PMDETA, 0.04 M EBP, 5.8 M MA and 0.64 M 1-octene) was found to increase linearly with monomer conversion. At the same time, the polydispersity remained low (i.e., M_{w}/Mₙ≦1.1) for up to 60% monomer conversion, beyond which it increased to about 1.2.

More significantly, the “living” nature of the copper-mediated copolymerization process allowed the synthesis of unique block copolymers. This can be illustrated by Examples 21-23, the results of which are summarized in Table 8.

### EXAMPLE 26

### Sequential Block Terpolymerization of Methyl Acrylate, Ethene and Propene

The synthesis of poly[(methyl acrylate-co-ethene)-b-(methyl acrylate-co-propene)] was performed in a two stage process, wherein the first stage was performed in accordance with the procedure of Example 1, except that 18 g. of MA were charged into the reactor (instead of 5.0 g. of MA), that ethene was charges at 700 psi.(instead of at 900 psi), and that the polymerization was terminated after only 1 hr (instead of after 16 hrs). Following this first stage, the reaction vessel was vented and flushed with purified nitrogen gas, and a polymer sample was recovered for molecular weight measurement. Propene (10 g.) was then charged into the reactor and the second polymerization stage was carried out for an additional 9 hrs (also at 90° C.). The molecular weight and composition of the final polymer also was determined. The results of this example summarised in Table 8.

### EXAMPLE 27

### Sequential Block Terpolymerization of Methyl Acrylate, Ethene and Propene

Poly[(methyl acrylate-co-ethene)-b-(methyl acrylate-co-propene)] was prepared in accordance with the two stage process set forth in Example 21, except that, in the first stage, 16 g. of MA was charged into the reactor (instead of 18 g. of MA), and that ethene was charged at 500 psi (instead of at 700 psi); and that, in the second stage, 15 g. of propene was charged (instead of 10 g. of propene, and that the second stage polymerization was terminated after 20 hrs (instead of after 9 hrs). Again, the results of this example are summarized in Table 8.

### EXAMPLE 28

### Sequential Block Terpolymerization of Methyl Acrylate, Ethene and Norbornene

CuBr (0.055 g, 0.38 mmol), PMDETA (0.080 mL, 0.38 mmol) and methyl acrylate (15.77 mL, 191.7 mmol) were placed in a glass liner equipped with a magnetic stirrer. The solution was stirred until it became homogeneous. MBP (0.064 g, 0.38 mmol) was then added to the glass liner. The resultant solution was placed in a 125 mL Parr steel autoclave, removed from the drybox and charged with ethene (500 psi, single charge). After stirring for 1 hr at 95° C., the autoclave was cooled to room temperature and unreacted ethene was released. The autoclave was flushed with nitrogen gas by three cycles of charge and release. A sample of the resulting first stage polymer was removed from the autoclave under a flow of nitrogen gas, and norbornene (7.30 g, 76.5 mmol) was then syringed into the autoclave. Polymerization (second stage) was resumed at 90° C. for an additional 17 hr. The products from the first stage polymerisation and the the second stage polymerization were dissolved in CHCl₃ and purified by filtration through alumina to remove the metal compound. The solvent was removed and the products were dried under vacuum to yield: Stage 1: ˜2% ethene incorporation; Mₙ=5,700; polydispoersity=1.18; Stage 2: ˜1% ethene and 10% norbomene incorporation; Mₙ=13,300; polydispersity=1.47. The results of this example are summarized in Table 8.

TABLE 8
Sequential block terpolymerization of methyl acrylate, ethene, and propene^{a}

| | | | | Comp. | | | | Final | Final |
|---|---|---|---|---|---|---|---|---|---|
| | First | Time | Mₙ | MA/E | Second | Time | Mₙ | Yield | Comp. |
| Ex. | Stage | (hr) | (M_{w}/Mₙ)^{b,c} | (mol %) | Stage | (hr) | (M_{w}/Mₙ)^{b,d} | (g) | (mol %) |
| 26 | MA, | 1 | 4,500 | 91.4/8.6 | P, 10 g | 9 | 32,000 | 11.0 | 89.7/3.1/7.2 |
| | 18 g | | (1.1) | | | | (1.1) | | MA/E/P |
| | E, | | | | | | | | |
| | 700 | | | | | | | | |
| | psi | | | | | | | | |
| 27 | MA, | 1 | 3,000 | 93.6/6.4 | P, 15 g | 20 | 48,000 | 10.8 | 86.6/2.2/11.2 |
| | 16 g | | (1.1) | | | | (1.1) | | MA/E/P |
| | E, | | | | | | | | |
| | 500 | | | | | | | | |
| | psi | | | | | | | | |
| 28^{e} | MA, | 1 | 5,700 | 98.0/2.0 | NB, | 17 | 13,300 | — | 89.0/1/10 |
| | 15.77 | | (1.18) | | 7.3 g | | (1.47) | | MA/E/NB |
| | M1 | | | | | | | | |
| | E, | | | | | | | | |
| | 500 | | | | | | | | |
| | psi | | | | | | | | |

^{a}Reaction conditions: CuBr, 0.23 mmol; EBP, 0.23 mmol; PMDETA, 0.23 mmol; 90° C.
^{b}Determined by GPC relative to polystyrene standards using refractive index detector.
^{c}After first charge.
^{d}For final product.
^{e}Reaction conditions: CuBr, 0.38 mmol; MBP, 0.38 mmol; PMDETA, 0.38 mmol; 95° C. first stage; 90° C. second stage.

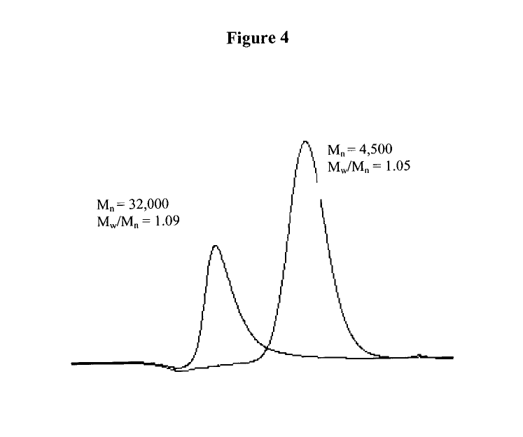

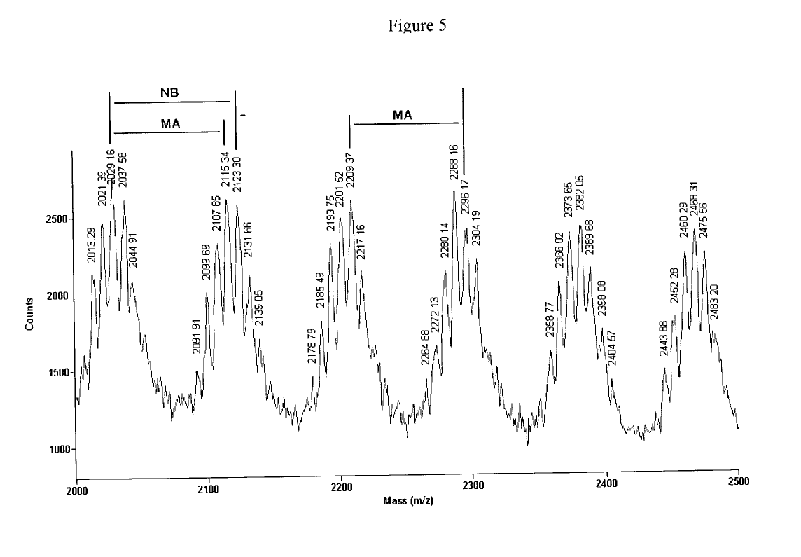

Referring to Table 4, Example 26, it will be seen that the molecular weight (Mₙ) increased from 4,500 for the poly(methyl acrylate-co-ethene) formed after the first polymerization stage, to 32,000 for the final poly[(methyl acrylate-co-ethene)-b-(methyl acrylate-co-propene)] formed after the second polymerization stage. Similarly, with reference to Example 23, the molecular weight (Mₙ) increased from 3,000 for the poly(methyl acrylate-co-ethene) formed after the first polymerisation stage, to 48,000 for the final poly[(methyl acrylate-co-ethene)-b-(methyl acrylate-co-propene)] formed after the second polymerization stage. At the same time, the polydispersities remained low, i.e., M_{w}/Mₙ=approximately 1.1 after both polymerisation stages for Example 26, as well as after both polymerisation stages for Example 27. The GPC traces obtained for the polymers formed after the first and second polymerisation stages for Example 26 are illustrated in FIG. 4.

Table 8 also shows similar results being obtained when norbornene was substituted for propene (Example 28) as the termonomer in the sequentially synthesized block terpolymers.

It will be appreciated that more than two sequential polymerisations stages could be employed to synthesize block tetrapolymers, etc. Typically, in cases where more than two polymerisation stages are to be used, the alkene monomer used in each stage is different from the alkene used in the next preceding stage. Also, it will be appreciated that more than one acrylate monomer and more than one alkene monomer may be used in any given stage.

What is claimed is:

1. A process for synthesizing a random copolymer of an acrylate monomer with at least one non-polar olefin monomer selected from the group consisting of ethene, linear or branched C₃ to C₁₀ olefins, norbornene and norbornene derivatives, which comprises contacting the acrylate monomer with the at least one olefin monomer in the presence of a copper-containing catalyst system with or without an inert diluent or solvent, and at temperature of from about 20 to about 150° C., to synthesize a random copolymer having a polydispersity (M_{w}/Mₙ) of less than about 1.7.

2. A process for synthesizing a random copolymer in accordance with claim 1, wherein said random copolymer having a polydispersity (M_{w}/Mₙ) of less than about 1.6.

3. A process for synthesizing a random copolymer in accordance with claim 1, wherein said acrylate monomer is selected from the group consisting of alkyl or aryl acrylates, hydroxyethyl acrylate, alkyl and aryl methacrylates, and mixtures thereof, wherein said at least one non-polar olefin monomer is selected from the group consisting of ethene, propene, 1-butene, 1-pentene, 1-hexene, 1-heptene, 1-octene, norbornene, 5-n-butyl-2-norbornene, 5-methylene-2-norbornene and 5-ethyl ester-2-norbornene, and mixtures thereof, wherein said copper-containing catalyst system comprises a copper-containing component, a halide-containing initiator component and a nitrogen-containing ligand component.

4. A process for synthesizing a random copolymer in accordance with claim 2, wherein said copper component is selected from the group consisting of CuBr, CuCl, and CuCN, wherein said bromine-containing initiator component is selected from the group consisting of methyl 2-bromopropionate, ethyl 2-bromopropionate, methyl 2-bromoisobutyrate, ethyl 2-bromoisobutyrate, and wherein said nitrogen-containing ligand component is selected from the group consisting of N,N,N′,N′,N″-pentamethyldiethylenetriamine (PMDETA), 1,1,4,7,10,10-hexamethyltriethylenetetraamine (HMTETA), bipyridine, and tetramethyl-ethylenediamine.

5. A process for synthesizing a random copolymer in accordance with claim 3, wherein said copper component is selected from the group consisting of CuBr, CuCl, and CuCN, wherein said bromine-containing initiator component is selected from the group consisting of methyl 2-bromopropionate, ethyl 2-bromopropionate, methyl 2-bromoisobutyrate, ethyl 2-bromoisobutyrate, and wherein said nitrogen-containing ligand component is selected from the group consisting of N,N,N′,N′,N″-pentamethyldiethylenetriamine (PMDETA), 1,1,4,7,10,10-hexamethyltriethylenetetraamine (HMTETA), bipyridine and tetramethyl-ethylenediamine

6. A process for synthesizing a random copolymer in accordance with claim 2, wherein said acrylate monomer is selected from the group consisting of alkyl or aryl acrylates, hydroxyethyl acrylate, alkyl and aryl methacrylates, and mixtures thereof, wherein said at least one non-polar olefin monomer is selected from the group consisting of ethene, propene, 1-butene, 1-pentene, 1-hexene, 1-heptene, and 1-octene, and mixtures thereof, wherein said copper component is selected from the group consisting of CuBr, CuCl and CuCN, wherein said bromine-containing initiator component is selected from the group consisting of methyl 2-bromopropionate(MBP), ethyl 2-bromopropionate (EBP), methyl 2-bromoisobutyrate (MBiB) and ethyl 2-bromoisobutyrate (EbiB), wherein said nitrogen-containing ligand component is selected from the group consisting of N,N,N′,N′,N″-pentamethyldiethylenetriamine (PMDETA), 1,1,4,7,10,10-hexamethyltriethylenetetraamine (HMTETA), bipyridine, and tetramethylethylenediamine, and wherein the polymerisation temperature is from about 20 to about 150° C.

7. A process for synthesizing a random copolymer in accordance with claim 2, wherein said acrylate monomer is selected from the group consisting of alkyl or aryl acrylates, hydroxyethyl acrylate, alkyl and aryl methacrylates, and mixtures thereof, wherein said at least one non-polar olefin monomer is selected from the group consisting of norbornene, 5-n-butyl-2-norbornene, 5-methylene-2-norbornene and 5-ethyl ester-2-norbornene, and mixtures thereof, wherein said copper component is selected from the group consisting of CuBr, CuCl and CuCN, wherein said bromine-containing initiator component is selected from the group consisting of methyl 2-bromopropionate(MBP), ethyl 2-bromopropionate (EBP), methyl 2-bromoisobutyrate (MBiB) and ethyl 2-bromoisobutyrate (EbiB), wherein said nitrogen-containing ligand component is selected from the group consisting of N,N,N′,N′,N″-pentamethyldiethylenetriamine (PMDETA), 1,1,4,7,10,10-hexamethyltriethylenetetraamine (HMTETA), bipyridine, and tetramethylethylenediamine, and wherein the polymerisation temperature is from about 20 to about 150° C.

8. A process for synthesizing block copolymers of an acrylate monomer with at least two non-polar olefin monomers selected from the group consisting of ethene, linear or branched C₃ to C₁₀ olefins, norbornene and norbornene derivatives, which comprises contacting an acrylate monomer with a first non-polar olefin monomer in the presence in the a copper-containing catalyst system with or without an inert diluent or solvent, and at temperature of from about 20 to about 150° C., to synthesize a first random copolymer having a polydispersity (M_{w}/Mₙ) of less than about 1.7; and then contacting said first random copolymer with a second olefin monomer, which is different from said first olefin monomer, in the presence in the a copper-containing catalyst system with or without an inert diluent or solvent, and at temperature of from about 20 to about 150° C., to thereby synthesize a block copolymer having a polydispersity (M_{w}/Mₙ) of less than about 1.7.

9. A process for synthesizing block copolymers in accordance with claim 8, wherein said first random copolymer has a polydispersity of less than about 1.6, and wherein said second random copolymer has a polydispersity of less than about 1.6.

10. A process for synthesizing block copolymers in accordance with claim 9, wherein said acrylate monomer is selected from the group consisting of alkyl or aryl acrylates, hydroxyethyl acrylate, alkyl and aryl methacrylates, and mixtures thereof, wherein said first non-polar olefin monomer is selected from the group consisting of ethene, propene, 1-butene, 1-pentene, 1-hexene, 1-heptene, 1-octene, norbornene, norbornene derivatives, and mixtures thereof, wherein said second non-polar olefin monomer is selected from the group consisting of ethene, propene, 1-butene, 1-pentene, 1-hexene, 1-heptene, 1-octene, norbornene and norbornene derivatives, and mixtures thereof, and wherein said copper-containing catalyst system comprises a copper component, a halide-containing initiator component and a nitrogen-containing ligand component.

11. A process for synthesizing block copolymers in accordance with claim 10, wherein said copper component is selected from the group consisting of CuBr, CuCl, CuCN, wherein said bromine-containing initiator component is selected from the group consisting of methyl 2-bromopropionate, ethyl 2-bromopropionate, methyl 2-bromoisobutyrate, ethyl 2-bromoisobutyrate, and wherein said nitrogen-containing ligand component is selected from the group consisting of N,N,N′,N′,N″-pentamethyldiethylenetriamine (PMDETA), 1,1,4,7,10,10-hexamethyltriethylenetetraamine HMTETA), bipyridine and tetramethyethylenediamine.

12. A process for synthesizing block copolymers in accordance with claim 11, wherein said acrylate monomer is selected from the group consisting of alkyl or aryl acrylates, hydroxyethyl acrylate, alkyl and aryl methacrylates, and mixtures thereof, and wherein said first non-polar olefin monomer is selected from the group consisting of ethene, propene, 1-butene, 1-pentene, 1-hexene, 1-heptene, and 1-octene, wherein said second non-polar olefin monomer is selected from the group consisting of ethene, propene, 1-butene, 1-pentene, 1-hexene, 1-heptene, and 1-octene.

13. A process for synthesizing block copolymers in accordance with claim 9, which comprises contacting the block copolymer with a third non-polar olefin monomer, in the presence in the a copper-containing catalyst system and an inert diluent or solvent, and at temperature of from about 20 to about 150° C., to thereby synthesize a second block copolymer having a polydispersity (M_{w}/Mₙ) of less than about 1.6, with the proviso that said third non-polar olefin monomer is different from said second non-polar olefin monomer, and, optionally, repeating the contacting step, each time with a non-polar olefin monomer which is different from the non-polar olefin monomer used in the next preceding contacting step.

14. A random copolymer prepared in accordance with process of claim 1.

15. A random copolymer prepared in accordance with the process of claim 2.

16. A block copolymer prepared in accordance with process of claim 8.

17. A block copolymer prepared in accordance with the process of claim 9.

18. A random copolymer of an acrylate monomer with at least one non-polar olefin monomer selected from the group consisting of ethene, linear or branched C₃ to C₁₀ olefins, norbornene and norbornene derivatives, said copolymer containing from about 5 to about 50 mol % olefin-derived units and having a polydispersity of less than about 1.7

19. A random copolymer in accordance with claim 18, wherein said copolymer has a polydispersity of less than about 1.6.

20. A random copolymer in accordance with claim 19, wherein said copolymer has a polydispersity of between about 1.1 and about 1.4.

21. A block copolymer comprising a block of a first random copolymer of an acrylate monomer with at least one non-polar olefin monomer selected from the group consisting of ethene, linear or branched C₃ to C₁₀ olefins, norbornene and norbornene derivatives, said first random copolymer containing from about 5 to about 50 mol % olefin-derived units and having a polydispersity of less than about 1.7, and a block of a second random copolymer of said first random copolymer with at least one non-polar olefin monomer selected from the group consisting of ethene, linear or branched C₃ to C₁₀ olefins, norbornene and norbornene derivatives, wherein said second random copolymer has a polydispersity of less than about 1.7.

22. A block copolymer in accordance with claim 21, wherein the polydispersity of said first random copolymer is less than about 1.6, and wherein the polydispersity of said second random copolymer is less than about 1.6.
